(19) United States
(12) Patent Application Publication
(10) Pub. No.: US 2025/0233302 A1
(43) Pub. Date: Jul. 17, 2025

(54) ANTENNA DEVICE AND IC CARD PROVIDED THEREWITH

(71) Applicant: TDK Corporation, Tokyo (JP)

(72) Inventor: Shoma KAJIKIYA, Tokyo (JP)

(21) Appl. No.: 18/412,359

(22) Filed: Jan. 12, 2024

(51) Int. Cl. H01Q 1/38; G06K 19/077

(52) U.S. Cl. CPC H01Q 1/38; G06K 19/07773

(57) ABSTRACT

Disclosed herein is an antenna device that includes a substrate having a first surface and a second surface opposite to the first surface, a coil pattern provided on the first surface of the substrate, a capacitor electrode pattern provided on the first surface of the substrate and connected to an innermost turn of the coil pattern, and a magnetic body overlapping the capacitor electrode pattern and at least a part of the coil pattern. The capacitor electrode pattern includes a plurality of linear patterns extending in parallel to one another. No other conductor pattern that faces the capacitor electrode pattern through an insulating material is provided between the capacitor electrode pattern and the magnetic body. No other conductor pattern is provided at a position on the second surface of the substrate that overlaps the capacitor electrode pattern.

### BACKGROUND

The present disclosure relates to an antenna device and an IC card provided therewith.

JP H11-353440A discloses an IC card having a coil pattern provided on one surface of a substrate thereof and a capacitor electrode pattern provided on both surfaces of the substrate. However, the formation of a capacitor using both surfaces of the substrate involves the formation of a via conductor in the substrate to increase manufacturing cost. JP 2001-307053A has a capacitor formed by providing a plurality of parallel linear patterns on one surface of a substrate.

However, the configuration disclosed in JP 2001-307053A has difficulty in obtaining sufficient capacitance.

### SUMMARY

An antenna device according to one embodiment of the present disclosure includes a substrate having a first surface and a second surface opposite to the first surface, a coil pattern provided on the first surface of the substrate, a capacitor electrode pattern provided on the first surface of the substrate and connected to an innermost turn of the coil pattern, and a magnetic body overlapping the capacitor electrode pattern and at least a part of the coil pattern. The capacitor electrode pattern includes a plurality of linear patterns extending in parallel to one another. No other conductor pattern that faces the capacitor electrode pattern through an insulating material is provided between the capacitor electrode pattern and the magnetic body. No other conductor pattern is provided at a position on the second surface of the substrate that overlaps the capacitor electrode pattern.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the outer appearance of an IC card 3 having an antenna device according to an embodiment of the present disclosure;

FIG. 2 is a schematic exploded perspective view for explaining the structure of the IC card 3 having an antenna device according to the first embodiment of the present disclosure;

FIG. 3 is a schematic cross-sectional view for explaining the structure of the IC card 3 having an antenna device according to the first embodiment of the present disclosure;

FIG. 4 is a schematic plan view of the conductor patterns formed on the surface 21 of the substrate 20 in the first embodiment;

FIG. 5 is a schematic cross-sectional view for explaining a mechanism in which capacitance is obtained by the capacitor electrode pattern 400;

FIG. 6 is a schematic perspective view illustrating the IC module 50 as viewed from its back side;

FIG. 7 is a schematic diagram showing a state in which the IC card 3 and the card reader 6 communicate;

FIG. 8 is a view for explaining the configuration of an antenna device 1A according to a first modification of the first embodiment;

FIG. 9 is a view for explaining the configuration of an antenna device 1B according to a second modification of the first embodiment;

FIG. 10 is a view for explaining the configuration of an antenna device 1C according to a third modification of the first embodiment;

FIG. 11 is a view for explaining the configuration of an antenna device 1D according to a fourth modification of the first embodiment;

FIG. 12 is a view for explaining the configuration of an antenna device 1E according to a fifth modification of the first embodiment;

FIG. 13 is a view for explaining the configuration of an antenna device 1F according to a sixth modification of the first embodiment;

FIG. 14 is a view for explaining the configuration of an antenna device 2 according to a second embodiment of the present disclosure;

FIG. 15 is a view for explaining the configuration of an antenna device 2A according to a first modification of the second embodiment;

FIG. 16 is a view for explaining the configuration of an antenna device 2B according to a second modification of the second embodiment;

FIG. 17 is a view for explaining the configuration of an antenna device 2C according to a third modification of the second embodiment;

FIG. 18 is a view for explaining the configuration of an antenna device 2D according to a fourth modification of the second embodiment;

FIG. 19 is a view for explaining the configuration of an antenna device 2E according to a fifth modification of the second embodiment;

FIG. 20 is a schematic cross-sectional view for explaining the configuration of an IC card 3A according to a third embodiment of the present disclosure; and

FIG. 21 is a schematic cross-sectional view for explaining the configuration of an IC card 3B according to a modification of the third embodiment.

### DETAILED DESCRIPTION OF THE EMBODIMENTS

An object of the present disclosure to provide an antenna device capable of obtaining larger capacitance while suppressing an increase in manufacturing cost.

Preferred embodiments of the present disclosure will be explained below in detail with reference to the accompanying drawings.

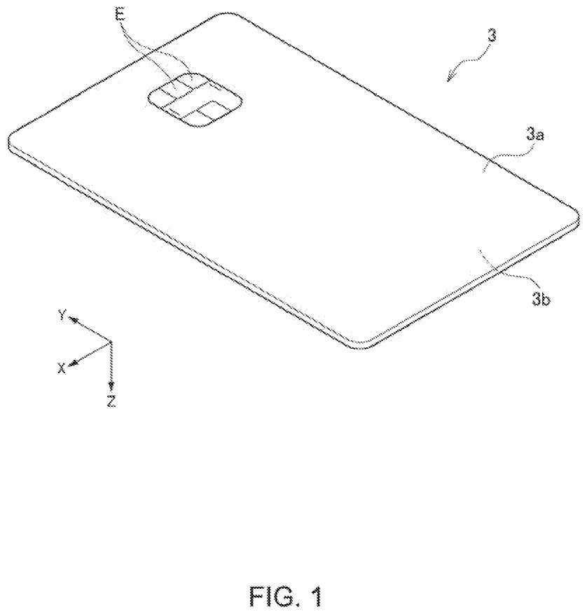

FIG. 1 is a schematic perspective view illustrating the outer appearance of an IC card 3 having an antenna device according to an embodiment of the present disclosure.

As illustrated in FIG. 1, the IC card 3 according to the present embodiment has a plate-like shape in which the Y-, X-, and Z-directions are defined as the longer side direction, shorter side direction, and thickness direction, respectively, and has an upper surface 3a and a back surface 3b which constitute the XY plane. The IC card 3 incorporates therein an IC module (to be described later) whose terminal electrode E is exposed to the upper surface 3a of the IC card.

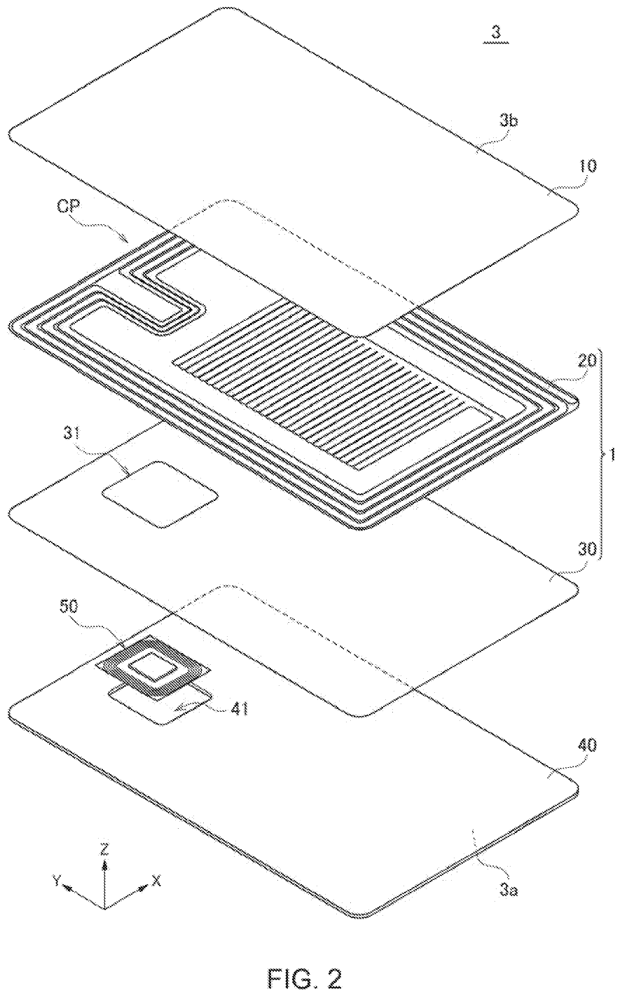

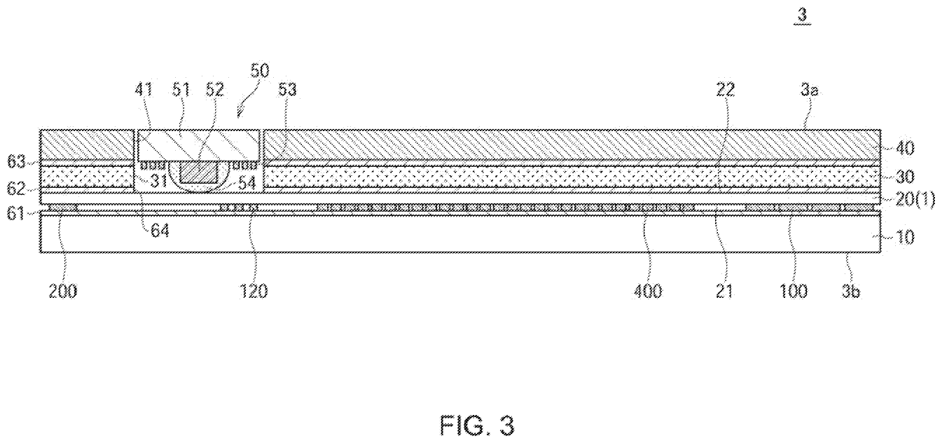

FIGS. 2 and 3 are respectively a schematic exploded perspective view and a schematic cross-sectional view for explaining the structure of the IC card 3 having an antenna device according to the first embodiment of the present disclosure.

The IC card 3 illustrated in FIGS. 2 and 3 has a structure in which a plastic plate 10, a substrate 20, a magnetic body 30, and a metal plate 40 are laminated in this order from the back surface 3b side to the upper surface side 3a. The plastic plate 10 is made of a resin material not hindering the passage of magnetic flux. The surface of the plastic plate 10 constitutes the back surface 3b of the IC card 3. The metal plate 40 is made of a metal material such as stainless steel or titanium. The surface of the metal plate 40 constitutes the upper surface 3a of the IC card 3. The metal plate 40 has a through hole 41 inside of which an IC module 50 is disposed. As described above, the IC card 3 is a card having a body using a metal plate.

The substrate 20 is a film made of an insulating resin material and has a coil pattern CP and a capacitor electrode pattern 400 on one surface 21 thereof. As an example of the insulating resin material constituting a film-like substrate 20, PET (Polyethylene Terephthalate, PI (Polyimide), and the like can be taken. The surface 21 of the substrate 20 faces the plastic plate 10, and a surface 22 of the substrate 20 on the opposite side faces the metal plate 40 through the magnetic body 30. The plastic plate 10 and substrate 20 are stuck to each other through an adhesive layer 61.

The surface 22 of the substrate 20 is covered with the magnetic body 30. The magnetic body 30 may be a sheet-like member or a coated body coated onto the surface 22 of the substrate 20. When the magnetic body 30 is a sheet-like member, the magnetic body 30 and substrate 20 are stuck to each other through an adhesive layer 62 as illustrated in FIG. 3. When the magnetic body 30 is a coated body coated onto the surface 22 of the substrate 20, the magnetic body 30 and substrate 20 are directly stuck to each other without an adhesive layer.

The magnetic body 30 and adhesive layer 62 have through holes 31 and 64, respectively, at a position overlapping the IC module 50. The antenna device 1 according to the present embodiment is constituted by the substrate 20, conductor patterns formed on the surface 21 of the substrate 20, and the magnetic body 30 covering the surface 22 of the substrate 20. No conductor pattern is formed on the surface 22 of the substrate 20. As described above, the conductor patterns are formed only on the surface 21 of the substrate 20, so that a through hole conductor that penetrates the substrate 20 need not be formed. Thus, even when the magnetic body 30 is coated onto the surface 22 of the substrate 20, the magnetic body 30 does not leak to the surface 21 side of the substrate 20 through a through hole. The through hole 41 formed in the metal plate 40 overlaps the through hole 31 of the magnetic body 30 in a plan view (viewed in the Z-direction) The magnetic body 30 and metal plate 40 are stuck to each other through an adhesive layer 63.

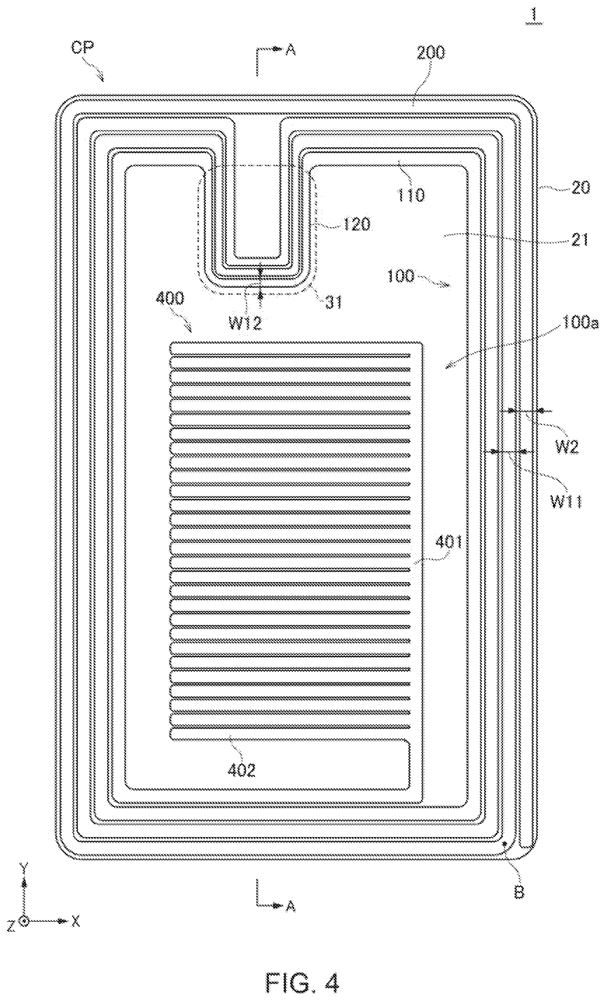

FIG. 4 is a schematic plan view of the conductor patterns formed on the surface 21 of the substrate 20 in the first embodiment. The line A-A illustrated in FIG. 4 indicates the sectional position in FIG. 3. In FIG. 4, the through hole 31 of the magnetic body 30 positioned on the surface 22 side of the substrate 20 is denoted by a dashed line.

As illustrated in FIG. 4, first and second coil patterns 100 and 200 constituting the coil pattern CP and a capacitor electrode pattern 400 are provided on the surface 21 of the substrate 20. These patterns are each made of a conductive material such as copper, aluminum, or an alloy thereof.

The first coil pattern 100 includes a first winding part 110 wound along the outer edge of the substrate 20 so as to overlap the magnetic body 30 and a second winding part 120 connected to turns of the first winding part 110 and wound along the inner edge of the through hole 31 of the magnetic body 30. The second winding part 120 is wound so as to protrude toward an opening 100a of the first coil pattern 100. That is, each turn of the first coil pattern 100 includes the first winding part 110 wound in less than one turn and the second winding part 120 wound in less than one turn.

The first winding part 110 functions as an antenna coil to be coupled to an external card reader in actual use. The second winding part 120 functions as a coupling coil to be coupled to the IC module 50. Although the second coil pattern 200 also functions as a part of the antenna coil, it mainly acts to adjust characteristics such as inductance. In the example illustrated in FIG. 4, the number of turns of the first coil pattern 100 is about three, and that of the second coil pattern 200 is about one. The boundary B illustrated in FIG. 4 is the boundary between the first coil pattern 100 and the second coil pattern 200 and is defined as a position wound by one turn from the outer puerperal end of the coil pattern CP. Alternatively, when there is a difference between the pattern width of the first coil pattern and that of the second coil pattern 200, the boundary B may be defined as a position at which the pattern width changes. The outer peripheral end of the coil pattern C is not connected to any external circuits and is opened.

In the first coil pattern 100, when the outer peripheral end (boundary B) is set as a winding starting point, the first winding part 110 is wound left-handed (counterclockwise), while the second winding part 120 is wound right-handed (clockwise). That is, the first winding part 110 and second winding part 120 are wound in mutually opposite directions. The second coil pattern 200 is wound in the same direction as the first winding part 110 of the first coil pattern 100. When the pattern widths of the first winding part 110, second winding part 120, and second coil pattern 200 are assumed to be W11, W12, and W2, respectively, W11=W2>W12 is satisfied in the example illustrated in FIG. 4. This allows the second winding part 120 of the first coil pattern 100 to be disposed in a limited space while reducing the resistance value of the first winding part 110 of the first coil pattern 100 and that of the second coil pattern 200. Further, the pattern width W11 of the first winding part 110 of the first coil pattern 100 is sufficiently ensured, so that a low resistance value can be achieved even with a reduction in the pattern thickness. The pattern width W11 may be larger than a pattern width W4 of a linear pattern 402 to be described later.

The first winding part 110 of the first coil pattern 100 and the second coil pattern 200 each entirely overlap the magnetic body 30, while the second winding part 120 of the first coil pattern 100 is wound along the inside of the three sides of the inner edge of the through hole 31 so as to overlap the through hole 31 of the magnetic body 30. Thus, at least a part of the second winding part 120 of the first coil pattern 100 does not overlap the magnetic body 30. The second winding part 120 of the first coil pattern 100 overlaps, in the Z-direction, the IC module 50 disposed in the through hole 41 of the metal plate 40 through the through hole 31 of the magnetic body 30.

The capacitor electrode pattern 400 is disposed in the opening 100a of the first coil pattern 100 and is connected to the inner peripheral end of the first coil pattern 100. The capacitor electrode pattern 400 includes a linear pattern 401 extending in the Y-direction and a plurality of linear patterns 402 branching from the linear pattern 401 and extending in the X-direction. The extending direction of the linear patterns 402 need not completely coincide with the X-direction. Further, the linear patterns 402 need not extend completely linearly but may be bent in the middle thereof, or may have a meandering shape in which the extending direction periodically changes. Furthermore, the plurality of linear patterns 402 need not be completely parallel to one another. As described above, no conductor pattern is formed on the surface 22 of the substrate 20, so that the capacitor electrode pattern 400 overlaps the magnetic body 30 through the substrate 20 but not through other conductor patterns between the substrate 20 and the magnetic body 30. In other words, no conductor pattern that faces the capacitor electrode pattern 400 through an insulating material is provided between the capacitor electrode pattern 400 and the magnetic body 30, and no conductor pattern is provided at a part of the surface 22 of the substrate 20 that overlaps the capacitor electrode pattern 400. The capacitor electrode pattern 400 is a terminated conductor pattern, and thus, the coil pattern CP has a structure in which both ends thereof are opened.

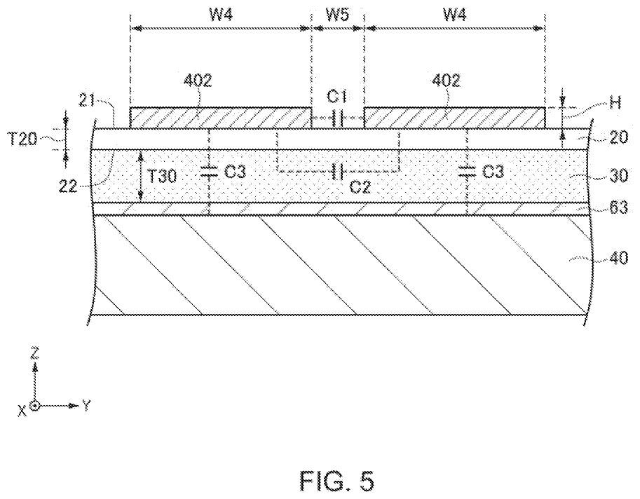

FIG. 5 is a schematic cross-sectional view for explaining a mechanism in which capacitance is obtained by the capacitor electrode pattern 400.

As illustrated in FIG. 5, although the linear patterns 402 of the capacitor electrode pattern 400 each have no counter electrode thereagainst that face in the Z-direction, capacitance occurs between the linear patterns 402 adjacent in the Y-direction. The capacitance thus occurring includes not only a component C1 directly occurring between the linear patterns 402 adjacent in the Y-direction but also a component C2 occurring through the magnetic body 30. When the pattern width of the linear patterns 402 in the X-direction is assumed to be W4, and the space between the linear patterns 402 adjacent in the X-direction is assumed to be W5, W4>W5 is satisfied, and thus the opposing area to the magnetic body 30 is sufficiently ensured. A thickness H of the linear patterns 402 in the Z-direction is sufficiently smaller than the space W5 between the linear patterns 402, whereby the amount of the component C1 directly occurring is quite small.

However, the linear pattern 42 overlaps the magnetic body 30 through the substrate 20, so that the capacitance is enhanced by the component C2 occurring through the magnetic body 30. The capacitance component C2 becomes larger as a thickness T20 of the substrate 20 is smaller and as the dielectric constant of the substrate 20 is higher in a state where the dielectric constant of the substrate 20 is lower than that of the magnetic body 30. Therefore, the thickness T20 of the substrate 20 may be smaller than a thickness T30 of the magnetic body 30. The dielectric constant of the magnetic body 30 may be several tens of times or several hundreds of times the dielectric constant of the substrate 20. For example, when the substrate 20 is made of PET (dielectric constant ε=about 3), the dielectric constant ε of the magnetic body 30 may be about 1000. As described above, the magnetic body 30 may be a sheet-like member or a coated body coated onto the surface 22 of the substrate 20. In either case, a material obtained by mixing magnetic metal powder made of Fe—Si—Cr based alloy magnet, Fe—Si—Al—Cr based alloy magnet, or Fe—Al—Cr based alloy magnet and binder resin may be used as the magnetic body 30. To further enhance the component C2, the magnetic metal powder contained in the magnetic body 30 is desirably flattened in the XY plane direction to have a flat shape having a reduced thickness in the Z-direction.

Further, in the present embodiment, the metal plate 40 is provided on the opposite side of the substrate 20 with respect to the magnetic body 30, so that a component C3 occurs through the metal plate 40. An electric field applied to the substrate 20 functioning as a dielectric forming the component C2 is enhanced by the component C3, and the electric field is spread in the plane of the linear pattern 402, thus increasing the component C2.

According to such a mechanism, although the linear patterns 402 have no counter electrode thereagainst, it is covered with the magnetic body 30, adhesive layer 63, and metal plate 40 through the substrate 20, so that large capacitance can be achieved due to the existence of the component C2.

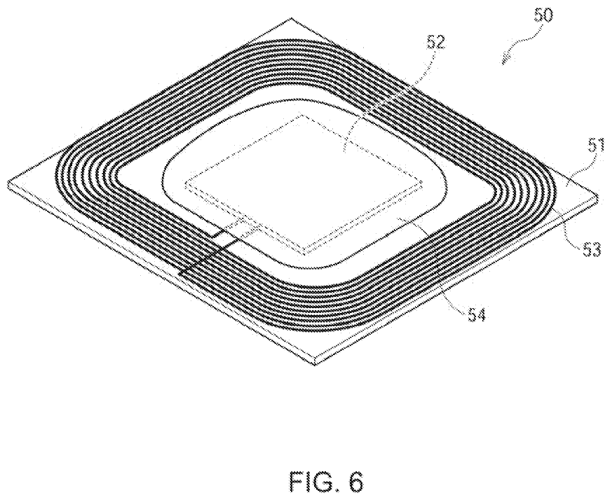

FIG. 6 is a schematic perspective view illustrating the IC module 50 as viewed from its back side.

As illustrated in FIG. 6, the IC module 50 includes a module substrate 51, an IC chip 52 mounted on or incorporated in the module substrate 51, and a coupling coil 53. The IC chip 52 is protected by being covered with a dome-shaped protective resin 54. The protective resin 54 is made of an insulating member. The terminal electrode E illustrated in FIG. 1 is provided on the front surface side of the module substrate 51. The IC module 50 thus configured is accommodated in the through hole 41 formed in the metal plate 40. In a state where the IC module 50 is accommodated in the through hole 41, the coupling coil 53 and the second winding part 120 of the first coil pattern 100 provided on the substrate 20 are electromagnetically coupled to each other. Since the second winding part 120 is connected to the first winding part 110 functioning as an antenna coil, the IC module 50 can communicate with an external device through the coil pattern CP.

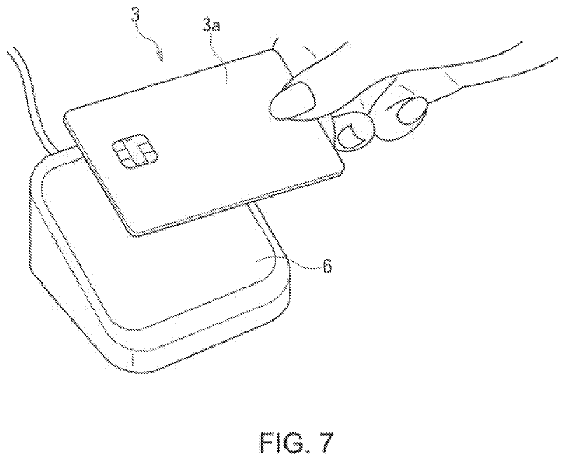

Thus, as illustrated in FIG. 7, when the back surface 3b of the IC card 3 is made to face a card reader 6, communication can be performed between the card reader 6 and the IC chip 52. That is, the card reader 6 is coupled to the coupling coil 53 of the IC module 50 through the coil pattern CP and can thereby communicate with the IC chip 52.

As described above, according to the present embodiment, the capacitor electrode pattern 400 connected to the inner peripheral end of the first coil pattern 100 includes the plurality of linear patterns 402, and the linear patterns 402 are covered with the magnetic body 30 and metal plate 40 through the substrate 20. This allows the antenna device 1 according to the present embodiment to achieve large capacitance even with no counter electrode on the surface 22 of the substrate 20. Thus, the resonance frequency of the antenna device 1 can be easily adjusted without increasing the number of turns of the coil pattern, making it is possible to suppress degradation in characteristics due to an increase in resistance and an excessive increase in inductance which are brought about in association with an increase in the number of turns of the coil pattern. Further, in the present embodiment, no conductor pattern is formed on the surface 22 of the substrate 20, so that it is not necessary to form a via conductor in the substrate 20, allowing a reduction in manufacturing cost.

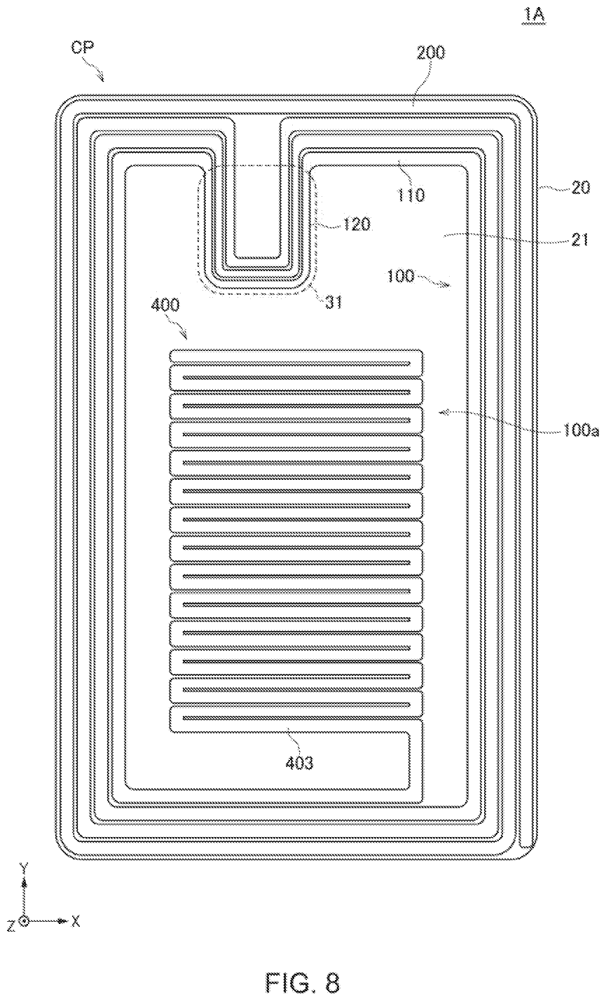

FIG. 8 is a view for explaining the configuration of an antenna device 1A according to a first modification of the first embodiment, which illustrates conductor patterns formed on the surface 21 of the substrate 20.

The first modification illustrated in FIG. 8 differs from the antenna device 1 according to the first embodiment in that the capacitor electrode pattern 400 has a meandering pattern 403. Other basic configurations are the same as those of the antenna device 1 according to the first embodiment, so the same reference numerals are given to the same elements, and overlapping description will be omitted. As in the first modification, the capacitor electrode pattern 400 need not have a comb shape but may have a meandering shape.

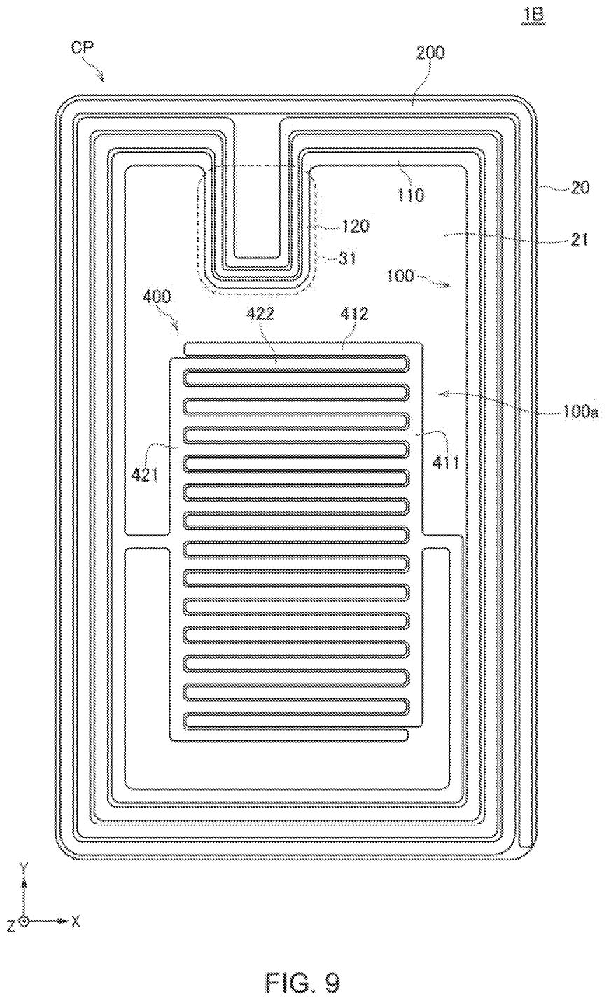

FIG. 9 is a view for explaining the configuration of an antenna device 1B according to a second modification of the first embodiment, which illustrates conductor patterns formed on the surface 21 of the substrate 20.

In the second modification illustrated in FIG. 9, the capacitor electrode pattern 400 has a plurality of linear patterns 412 and 422. The linear patterns 412 and 422 extend in the X-direction and are arranged in the Y-direction. The linear patterns 412 are connected to the inner peripheral end of the first coil pattern 100 through a linear pattern 411 extending in the Y-direction. The linear patterns 422 are connected, through a linear pattern 421 extending in the Y-direction, to a connection point on the innermost turn of the first coil pattern 100 that is positioned on the outer side than the inner peripheral end. Other basic configurations are the same as those of the antenna device 1 according to the first embodiment, so the same reference numerals are given to the same elements, and overlapping description will be omitted. As in the second modification, the capacitor electrode pattern 400 may have a configuration in which the comb-shaped linear patterns 411, 412 and comb-shaped linear patterns 421, 422 mesh with each other.

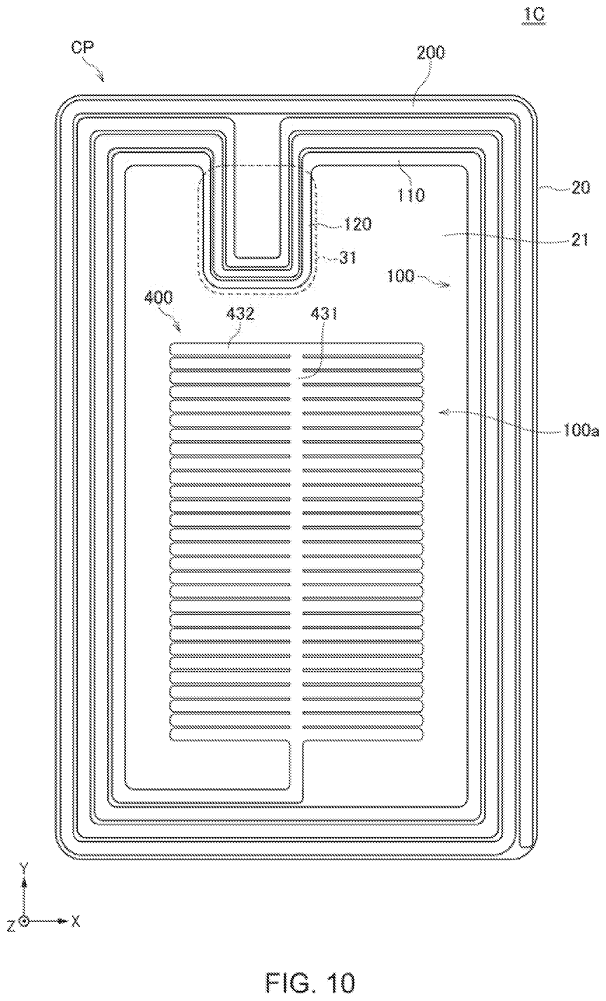

FIG. 10 is a view for explaining the configuration of an antenna device 1C according to a third modification of the first embodiment, which illustrates conductor patterns formed on the surface 21 of the substrate 20.

The third modification illustrated in FIG. 10 differs from the antenna device 1 according to the first embodiment in that the capacitor electrode pattern 400 includes a linear pattern 431 extending in the Y-direction and a plurality of linear patterns 432 branching from the linear pattern 431 and extending to both sides in the X-direction. Other basic configurations are the same as those of the antenna device 1 according to the first embodiment, so the same reference numerals are given to the same elements, and overlapping description will be omitted. As in the third modification, the shape of the linear pattern as a trunk line and the shape of the linear pattern branching from the trunk line are not particularly limited.

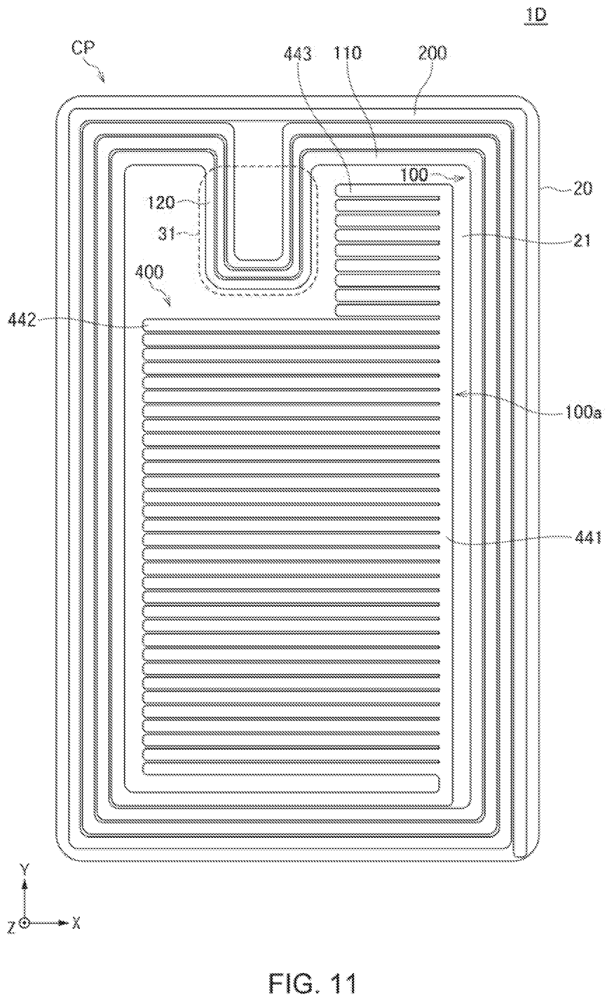

FIG. 11 is a view for explaining the configuration of an antenna device 1D according to a fourth modification of the first embodiment, which illustrates conductor patterns formed on the surface 21 of the substrate 20.

The fourth modification illustrated in FIG. 11 differs from the antenna device 1 according to the first embodiment in that the capacitor electrode pattern 400 includes a linear pattern 441 extending in the Y-direction and a plurality of linear patterns 442 and 443 branching from the linear pattern 441 and extending in the X-direction. Other basic configurations are the same as those of the antenna device 1 according to the first embodiment, so the same reference numerals are given to the same elements, and overlapping description will be omitted. The Y-direction position of the linear patterns 442 does not overlap the second winding part 120. The linear patterns 443 are provided at a position sandwiched in the X-direction between the first winding part 110 and the second winding part 120. The length of the linear patterns 442 in the X-direction is longer than the length of the linear patterns 443 in the X-direction. With this configuration, 50% or more of the area of the opening 100a of the first coil pattern 100 is occupied by the capacitor electrode pattern 400, allowing achievement of larger capacitance.

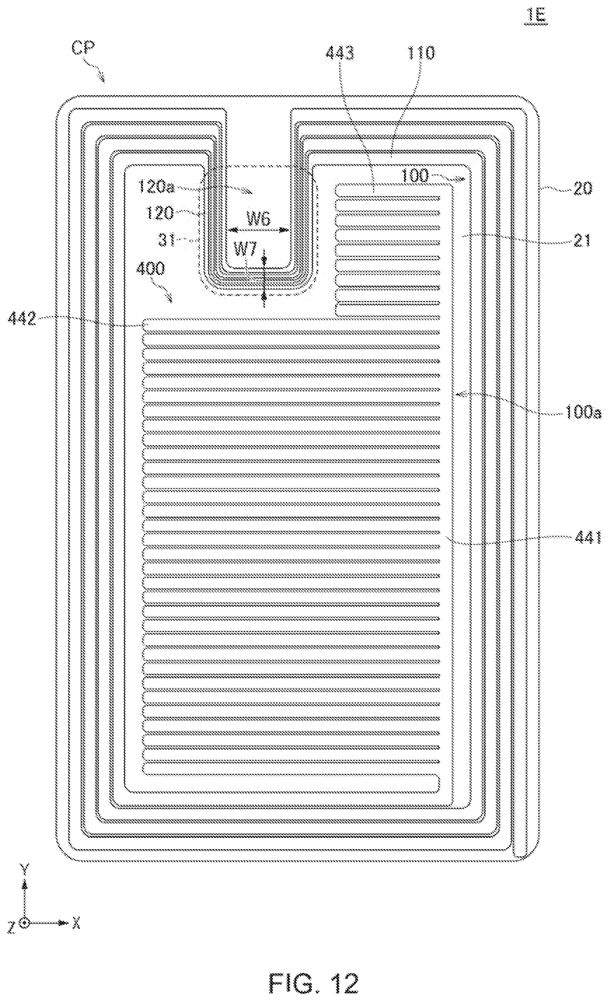

FIG. 12 is a view for explaining the configuration of an antenna device 1E according to a fifth modification of the first embodiment, which illustrates conductor patterns formed on the surface 21 of the substrate 20.

In the fifth modification illustrated in FIG. 12, the second coil pattern 200 is omitted; instead, the number of turns of the first coil pattern 100 is increased to four, and the pattern width of the second winding part 120 is reduced. An opening width W6 of an opening 120a of the second winding part 120 is larger than a winding width W7 of the second winding part 120. The winding width refers to the distance from the outer edge of the outermost turn to the inner edge of the innermost turn. Other basic configurations are the same as those of the antenna device 1D according to the fourth embodiment, so the same reference numerals are given to the same elements, and overlapping description will be omitted. With this configuration, the second winding part 120 can be disposed in a limited space even when the number of turns of the first coil pattern 100 is large.

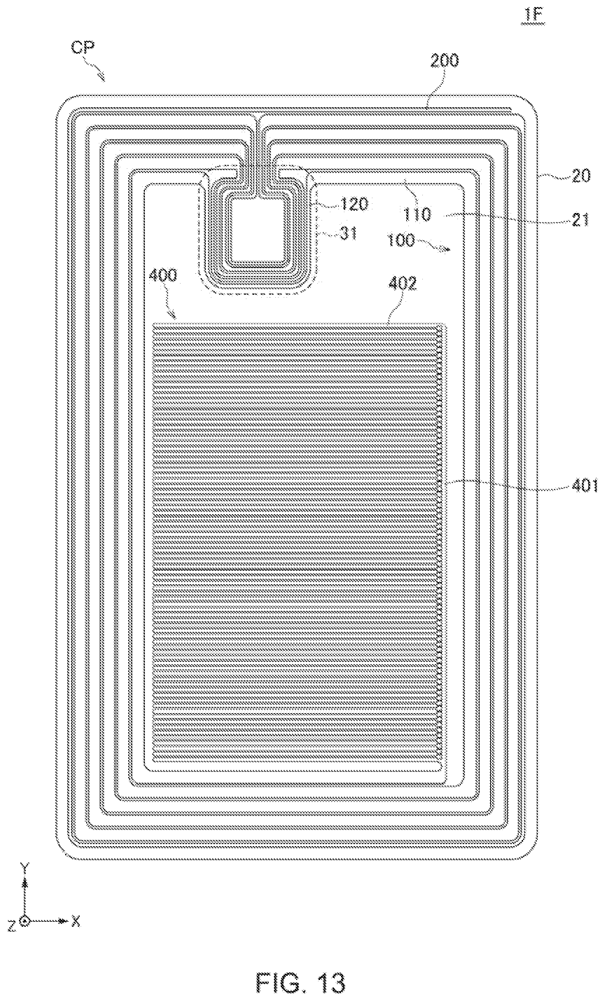

FIG. 13 is a view for explaining the configuration of an antenna device 1F according to a sixth modification of the first embodiment, which illustrates conductor patterns formed on the surface 21 of the substrate 20.

In the sixth modification illustrated in FIG. 13, the pattern width in the Y-direction of the linear patterns 402 extending in the X-direction is reduced and further reduced at connection portions between the linear patterns 42 and the linear pattern 401 extending in the Y-direction. Further, in the sixth modification illustrated in FIG. 13, the second winding part 120 includes a part wound along the inside of the four sides of the inner edge of the through hole 31 and a part wound along the inside of the three sides of the inner edge of the through hole 31. Specifically, a part of the second winding part 120 that is connected to the innermost turn of the first winding part 110 is wound along the inside of the three sides of the inner edge of the through hole 31, and the remaining part of the second winding part 120 that is connected to the turns of the first winding part 110 other than the innermost turn is wound along the inside of the four sides of the inner edge of the through hole 31. Other basic configurations are the same as those of the antenna device 1 according to the first embodiment, so the same reference numerals are given to the same elements, and overlapping description will be omitted. When the capacitor electrode pattern 400 having such a configuration is used, fine adjustment of capacitance is enabled by separating a desirable number of the linear patterns 402 from the linear pattern 401 using a trimming technique. Further, since the second winding part 120 includes a part wound along the inside of the four sides of the inner edge of the through hole 31, coupling between the second winding part 120 and IC module 50 is enhanced.

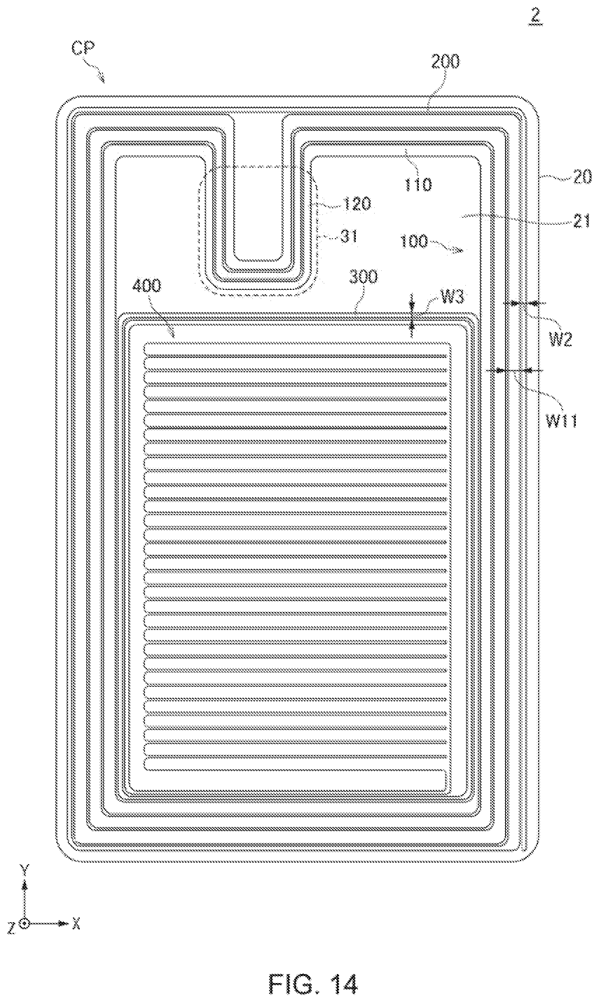

FIG. 14 is a view for explaining the configuration of an antenna device 2 according to a second embodiment of the present disclosure, which illustrates conductor patterns formed on the surface 21 of the substrate 20.

As illustrated in FIG. 14, the antenna device 2 according to the second embodiment differs from the antenna device 1 according to the first embodiment in that the coil pattern CP includes a third coil pattern 300. Other basic configurations are the same as those of the antenna device 1 according to the first embodiment, so the same reference numerals are given to the same elements, and overlapping description will be omitted.

The third coil pattern 300 is connected to the inner peripheral end of the first coil pattern 100 and wound in the same direction as the first winding part 110 along the outer periphery of the capacitor electrode pattern 400. Although the third coil pattern 300 functions as a part of the antenna coil, it mainly acts to adjust characteristics such as inductance. When there is a difference between the pattern width of the first coil pattern 100 and that of the third coil pattern 300, a position at which the pattern width changes may be defined as the boundary between the first and third coil patterns 100 and 300.

In the example illustrated in FIG. 14, the number of turns of the third coil pattern 300 is about two, while the number of turns of the second coil pattern 200 is about one. That is, the number of turns of the third coil pattern 300 is larger than that of the second coil pattern 200. However, the third coil pattern 300 is shorter in line length per turn than the second coil pattern 200, so that the line length of the third coil pattern 300 is substantially the same as the line length of the second coil pattern 200. As a result, the first coil pattern 100 is positioned at a point closer to the center of the line length of the coil pattern CP, thus increasing the density of current flowing in the second winding part 120.

In the example illustrated in FIG. 14, a pattern width W3 of the third coil pattern 300 is substantially the same as the pattern width W2 of the second coil pattern 200 and smaller than the pattern width W11 of the first winding part 110 of the first coil pattern 100. This reduces the occupied area of the second and third coil patterns 200 and 300 mainly used for inductance adjustment and, correspondingly, the pattern width of the first winding part 110 of the first coil pattern 100 can be sufficiently ensured.

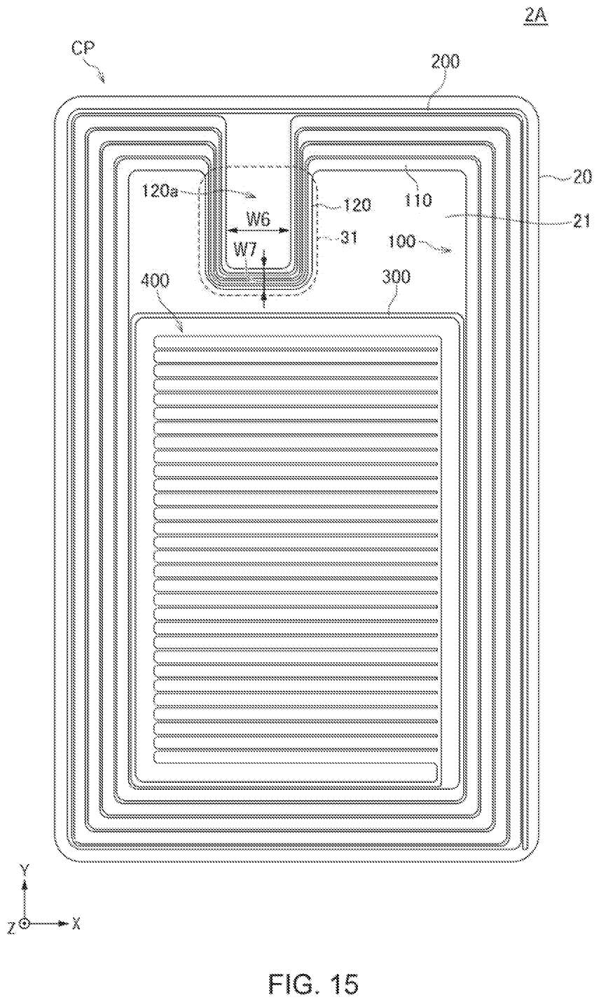

FIG. 15 is a view for explaining the configuration of an antenna device 2A according to a first modification of the second embodiment, which illustrates conductor patterns formed on the surface 21 of the substrate 20.

In the first modification illustrated in FIG. 15, the number of turns of the first coil pattern 100 is increased to four, the number of turns of the second coil pattern 200 is reduced to one, and the pattern width of the second winding part 120 is reduced. The opening width W6 of the opening 120a of the second winding part 120 is larger than the winding width W7 of the second winding part 120. Other basic configurations are the same as those of the antenna device 2 according to the second embodiment, so the same reference numerals are given to the same elements, and overlapping description will be omitted. With this configuration, it is possible to dispose the second winding part 120 in a limited space even with a large number of turns of the first coil pattern 100. Further, as in the present modification, the number of turns of the second coil pattern 200 may be the same as that of the third coil pattern 300.

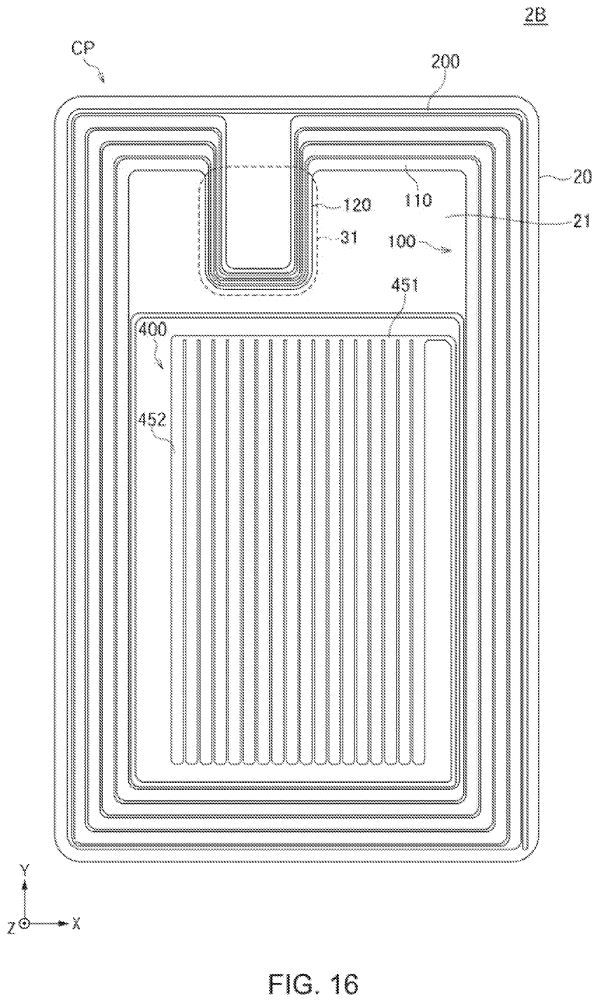

FIG. 16 is a view for explaining the configuration of an antenna device 2B according to a second modification of the second embodiment, which illustrates conductor patterns formed on the surface 21 of the substrate 20.

In the second modification illustrated in FIG. 16, the capacitor electrode pattern 400 includes a linear pattern 451 extending in the X-direction and a plurality of linear patterns 452 branching from the linear pattern 451 and extending in parallel in the Y-direction. The number of turns of the third coil pattern 300 is about 1.25. Other basic configurations are the same as those of the antenna device 2A according to the second embodiment, so the same reference numerals are given to the same elements, and overlapping description will be omitted. In the second modification, the difference between the line length of the second coil pattern 200 and that of the third coil pattern 300 is reduced by increasing the number of turns of the third coil pattern 300. As a result, the second winding part 120 is positioned at substantially the center of the line length, a point closer to the center of the line length of the coil pattern CP, thus allowing the density of current flowing in the second winding part 120 to be increased. That is, in the second modification, the difference between the line length of the third coil pattern 300 and that of the second coil pattern 200 is smaller than the difference therebetween when the number of turns of the third coil pattern 300 and that of the second coil pattern 200 are the same. Further, as in the second modification, the extending direction of the linear patterns constituting the capacitor electrode pattern 400 is not particularly limited.

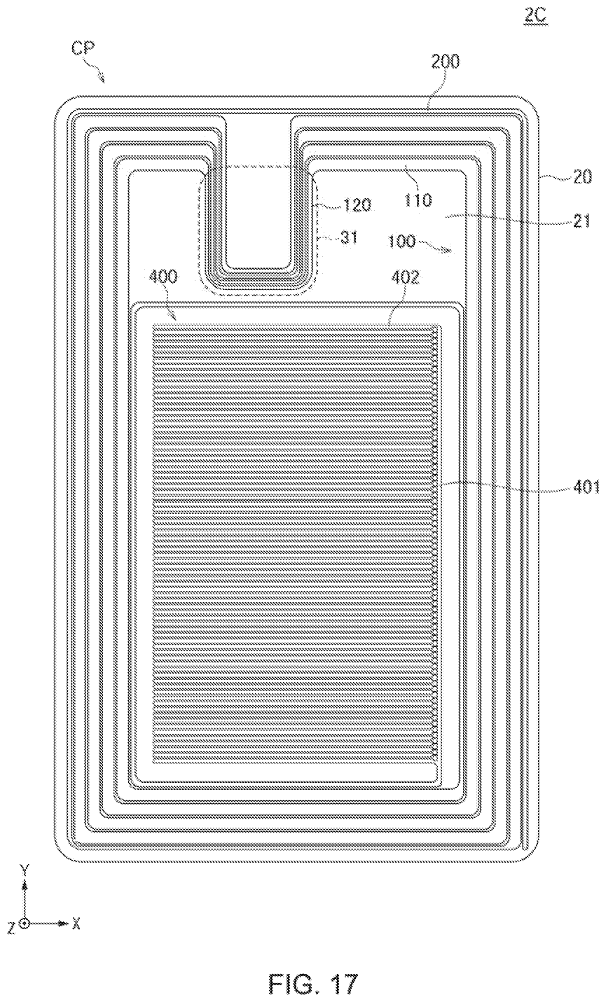

FIG. 17 is a view for explaining the configuration of an antenna device 2C according to a third modification of the second embodiment, which illustrates conductor patterns formed on the surface 21 of the substrate 20.

In the third modification illustrated in FIG. 17, the pattern width in the Y-direction of the linear patterns 402 extending in the X-direction is reduced and further reduced at connection portions between the linear patterns 402 and the linear pattern 401 extending in the Y-direction. Other basic configurations are the same as those of the antenna device 2A according to the first modification of the second embodiment, so the same reference numerals are given to the same elements, and overlapping description will be omitted. When the capacitor electrode pattern 400 having such a configuration is used, fine adjustment of capacitance is enabled by separating a desirable number of the linear patterns 402 from the linear pattern 401 using a trimming technique.

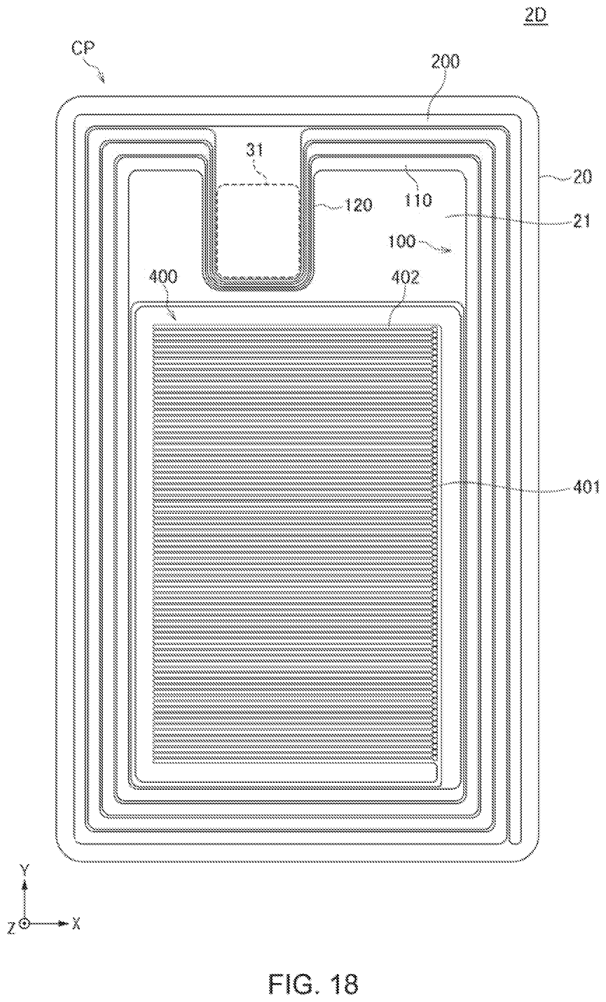

FIG. 18 is a view for explaining the configuration of an antenna device 2D according to a fourth modification of the second embodiment, which illustrates conductor patterns formed on the surface 21 of the substrate 20.

In the fourth modification illustrated in FIG. 18, the second winding part 120 of the first coil pattern 100 is wound along the outside of the inner edge of the through hole 31 so as to overlap the magnetic body 30. Accordingly, the second winding part 120 of the first coil pattern 100 overlaps in the Z-direction the IC module 50 disposed in the through hole 41 of the metal plate 40 through the magnetic body 30. Other basic configurations are the same as those of the antenna device 2C according to the third modification of the second embodiment, so the same reference numerals are given to the same elements, and overlapping description will be omitted. As in the present modification, the second winding part 120 of the first coil pattern 100 need not necessarily overlap the through hole 31 of the magnetic body 30, and it is sufficient that at least a part of the second winding part 120 overlaps the magnetic body 30.

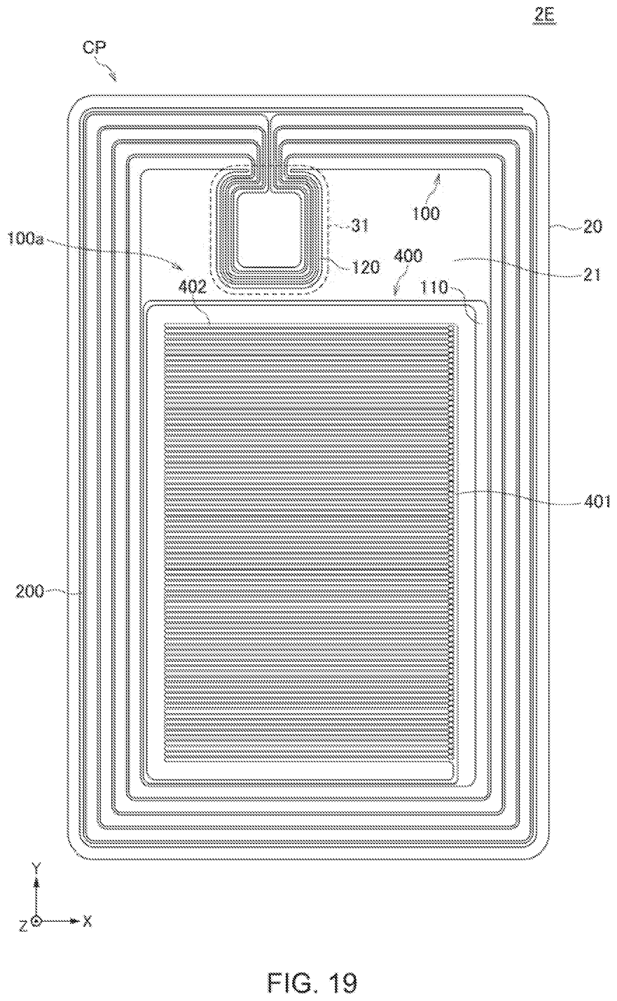

FIG. 19 is a view for explaining the configuration of an antenna device 2E according to a fifth modification of the second embodiment, which illustrates conductor patterns formed on the surface 21 of the substrate 20.

In the fifth modification illustrated in FIG. 19, the second winding part 120 is wound along the inside of the four sides of the inner edge of the through hole 31. Other basic configurations are the same as those of the antenna device 2C according to the third modification of the second embodiment, so the same reference numerals are given to the same elements, and overlapping description will be omitted. As described above, winding the second winding part 120 along the inside of the four sides of the inner edge of the through hole 31 further enhances coupling between the second winding part 120 and the IC module 50.

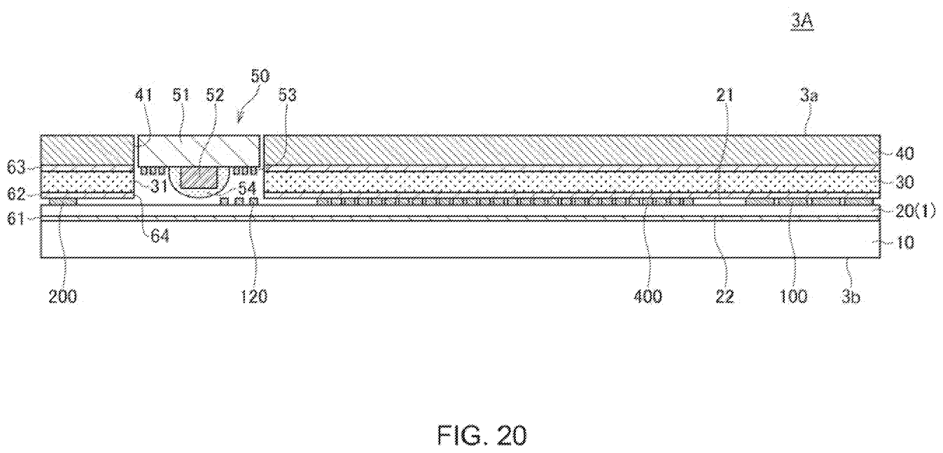

FIG. 20 is a schematic cross-sectional view for explaining the configuration of an IC card 3A according to a third embodiment of the present disclosure.

As illustrated in FIG. 20, in the IC card 3A according to the third embodiment, the substrate 20 is set with the front and back sides reversed, as compared with the configuration of the IC card 3 illustrated in FIG. 3. That is, the surface 21 of the substrate 20 having thereon the conductor patterns faces the magnetic body 30 side, and the surface 22 faces the plastic plate 10 side. Even in this case, no conductor pattern is formed on the surface 22 of the substrate 20, and only the adhesive layer 62 is interposed between the capacitor electrode pattern 400 and the magnetic body 30, meaning that there is no other conductor pattern that faces the capacitor electrode pattern 400 through an insulating material. Thus, only the positions are interchanged between the substrate 20 and the adhesive layer 62, and sufficient capacitance can be achieved by the mechanism described using FIG. 5. In addition, the distance between the capacitor electrode pattern 400 and the magnetic body 30 and the distance between the capacitor electrode pattern 400 and the metal plate 40 are further reduced to thereby achieve larger capacitance.

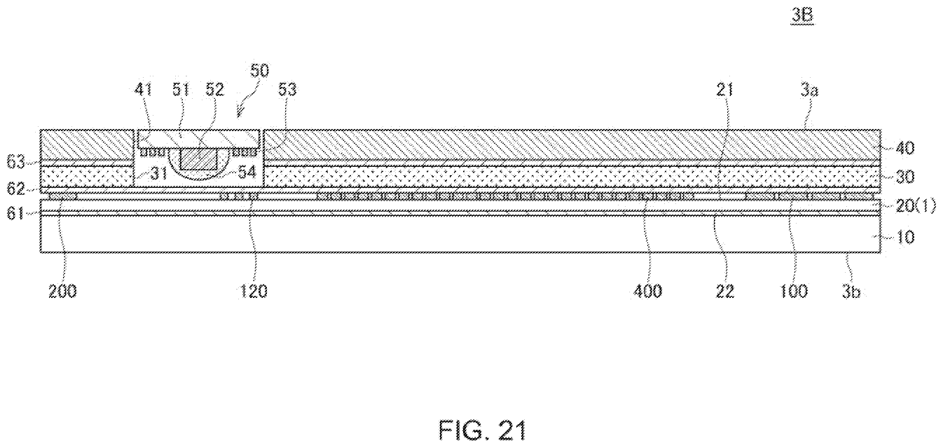

Further, in the example illustrated in FIG. 20, the through hole 64 is formed in the adhesive layer 62 so as to overlap the IC module 50, preventing the adhesive layer 62 from being exposed. On the other hand, in an IC card 3A according to a first modification illustrated in FIG. 21, the adhesive layer 62 has no through hole therein, so that the second winding part 120 is covered therewith, thus further enhancing the protection of the conductor patterns.

While the preferred embodiment of the present disclosure has been described, the present disclosure is not limited to the above embodiment, and various modifications may be made within the scope of the present disclosure, and all such modifications are included in the present disclosure.

For example, the conductor patterns formed on the surface 21 of the substrate 20 may be provided with another material layer containing resin interposed therebetween.

The technology according to the present disclosure includes the following configuration examples but not limited thereto.

An antenna device according to the present disclosure includes a substrate, a coil pattern and a capacitor electrode pattern which are provided on one surface of the substrate, the capacitor electrode pattern being connected to the innermost turn of the coil pattern, and a magnetic body overlapping the capacitor electrode pattern and at least a part of the coil pattern. The capacitor electrode pattern includes a plurality of linear patterns extending in parallel to one another. No other conductor pattern that faces the capacitor electrode pattern through an insulating material is provided between the capacitor electrode pattern and the magnetic body, and no conductor pattern is provided at a position on the other surface of the substrate that overlaps the capacitor electrode pattern. With this configuration, it is possible to provide an antenna device capable of obtaining larger capacitance while suppressing an increase in manufacturing cost.

In the above antenna device, the magnetic body may contain magnetic powder having a flat shape. This enhances the capacitance of the capacitor electrode pattern.

In the above antenna device, the magnetic body may be a sheet-like member stuck to the other surface of the substrate through an adhesive layer. This facilitates the formation of the magnetic body.

In the above antenna device, the magnetic body may directly contact the other surface of the substrate without an adhesive layer interposed therebetween. This further enhances the capacitance of the capacitor electrode pattern and allows the magnetic body to be formed by coating a magnetic material onto the other surface of the substrate.

In the above antenna device, the thickness of the substrate may be smaller than the thickness of the magnetic body. This allows larger capacitance to be obtained.

In the above antenna device, the capacitor electrode pattern may cover 50% or more of the opening area of the coil pattern. This allows larger capacitance to be obtained.

In the antenna device, the space between the plurality of linear patterns is smaller than the pattern width of each of the plurality of linear patterns.

In the antenna device, the magnetic body may have a through hole therein, the coil pattern may include a first coil pattern, and the first coil pattern may include a first winding part wound along the outer edge of the substrate so as to overlap the magnetic body and a second winding part whose turns are connected to respective turns of the first winding part and wound along the inner edge of the through hole in the opposite direction to the first winding part. This allows the second winding part to function as a coupling coil.

In the antenna device, at least a part of the second winding part may be wound along the inside of the inner edge of the through hole so as to overlap the through hole. This allows coupling to be achieved not through the magnetic body.

In the antenna device, at least a part of the second winding part may be wound along the outside of the inner edge of the through hole so as to overlap the magnetic body. This allows coupling to be achieved through the magnetic body.

In the antenna device, the pattern width of the second winding part may be smaller than the pattern width of the first winding part. This allows the second winding part to be disposed in a limited space even with a large number of turns of the first coil pattern.

In the antenna device, the coil pattern may further include a second coil pattern connected to the outer peripheral end of the first coil pattern and wound in the same direction as the first winding part along the outer periphery of the first winding part so as to overlap the magnetic body. This allows characteristics such as inductance to be finely adjusted by the second coil pattern.

In the antenna device, the coil pattern may further include a third coil pattern connected to the inner peripheral end of the first coil pattern and wound in the same direction as the first winding part along the outer periphery of the capacitor electrode pattern. This allows characteristics such as inductance to be finely adjusted by the third coil pattern.

In the antenna device, the pattern width of the second and third coil patterns may be smaller than the pattern width of the first winding part of the first coil pattern. This can sufficiently ensure the pattern width of the first winding part of the first coil pattern.

In the above antenna device, the difference between the line length of the third coil pattern and that of the second coil pattern may be smaller than the difference therebetween when the number of turns of the third coil pattern and that of the second coil pattern are the same. This can increase the density of current flowing in the second winding part of the first coil pattern.

In the antenna device, the pattern width of the plurality of linear patterns may be smaller than the pattern width of the first winding part of the first coil pattern. This can sufficiently ensure the pattern width of the first winding part of the first coil pattern.

In the antenna device, the opening width of the second winding part may be larger than the winding width of the second winding part. This allows the second winding part to be disposed in a limited space even with a large number of turns of the first coil pattern.

The antenna device according to the present disclosure may further include a metal plate that covers the magnetic body from the opposite side of the substrate. This can further enhance capacitance.

An IC card according to the present disclosure includes the above-described antenna device and an IC module. The metal plate has a through hole therein in which the IC module is disposed, and the through hole of the metal plate overlaps the through hole of the magnetic body. This can achieve coupling between the second winding part of the first coil pattern and the IC module.

What is claimed is:

1. An antenna device comprising:
a substrate having a first surface and a second surface opposite to the first surface;
a coil pattern provided on the first surface of the substrate;
a capacitor electrode pattern provided on the first surface of the substrate and connected to an innermost turn of the coil pattern; and
a magnetic body overlapping the capacitor electrode pattern and at least a part of the coil pattern,
wherein the capacitor electrode pattern includes a plurality of linear patterns extending in parallel to one another,
wherein no other conductor pattern that faces the capacitor electrode pattern through an insulating material is provided between the capacitor electrode pattern and the magnetic body, and
wherein no other conductor pattern is provided at a position on the second surface of the substrate that overlaps the capacitor electrode pattern.

2. The antenna device as claimed in claim 1, wherein the magnetic body contains magnetic powder having a flat shape.

3. The antenna device as claimed in claim 1, wherein the magnetic body is a sheet-like member stuck to the second surface of the substrate through an adhesive layer.

4. The antenna device as claimed in claim 1, wherein the magnetic body directly contacts the second surface of the substrate without an adhesive layer interposed therebetween.

5. The antenna device as claimed in claim 1, wherein a thickness of the substrate is smaller than a thickness of the magnetic body.

6. The antenna device as claimed in claim 1, wherein the capacitor electrode pattern covers 50% or more of an opening area of the coil pattern.

7. The antenna device as claimed in claim 1, wherein a space between the plurality of linear patterns is smaller than a pattern width of each of the plurality of linear patterns.

8. The antenna device as claimed in claim 1,
wherein the magnetic body has a through hole therein;
wherein the coil pattern includes a first coil pattern, and
wherein the first coil pattern includes:
a first winding part wound along an outer edge of the substrate so as to overlap the magnetic body; and
a second winding part whose turns are connected to respective turns of the first winding part and wound along an inner edge of the through hole in an opposite direction to the first winding part.

9. The antenna device as claimed in claim 8, wherein at least a part of the second winding part is wound along an inside of the inner edge of the through hole so as to overlap the through hole.

10. The antenna device as claimed in claim 8, wherein at least a part of the second winding part is wound along an outside of the inner edge of the through hole so as to overlap the magnetic body.

11. The antenna device as claimed in claim 8, wherein a pattern width of the second winding part is smaller than a pattern width of the first winding part.

12. The antenna device as claimed in claim 8, wherein the coil pattern further includes a second coil pattern connected to an outer peripheral end of the first coil pattern and wound in a same direction as the first winding part along an outer periphery of the first winding part so as to overlap the magnetic body.

13. The antenna device as claimed in claim 12, wherein the coil pattern further includes a third coil pattern connected to an inner peripheral end of the first coil pattern and wound in a same direction as the first winding part along an outer periphery of the capacitor electrode pattern.

14. The antenna device as claimed in claim 13, wherein a pattern width of the second and third coil patterns is smaller than a pattern width of the first winding part of the first coil pattern.

15. The antenna device as claimed in claim 13, wherein a difference between a line length of the third coil pattern and a line length of the second coil pattern is smaller than a difference therebetween when a number of turns of the third coil pattern and a number of turns of the second coil pattern are a same.

16. The antenna device as claimed in claim 8, wherein a pattern width of the plurality of linear patterns is smaller than a pattern width of the first winding part of the first coil pattern.

17. The antenna device as claimed in claim 8, wherein an opening width of the second winding part of the first coil pattern is larger than a winding width of the second winding part of the first coil pattern.

18. The antenna device as claimed in claim 8, further comprising a metal plate that covers the magnetic body from an opposite side of the substrate.

19. An IC card comprising:
an antenna device comprising:
a substrate having a first surface and a second surface opposite to the first surface;
a coil pattern provided on the first surface of the substrate;
a capacitor electrode pattern provided on the first surface of the substrate and connected to an innermost turn of the coil pattern; and
a magnetic body overlapping the capacitor electrode pattern and at least a part of the coil pattern;
a metal plate that covers the magnetic body from an opposite side of the substrate; and
an IC module,
wherein the magnetic body has a through hole therein,
wherein the metal plate has a through hole therein in which the IC module is disposed,
wherein the through hole of the metal plate overlaps the through hole of the magnetic body,
wherein the coil pattern includes a first coil pattern,
wherein the first coil pattern includes:
a first winding part wound along an outer edge of the substrate so as to overlap the magnetic body; and
a second winding part whose turns are connected to respective turns of the first winding part and wound along an inner edge of the through hole in an opposite direction to the first winding part,
wherein the capacitor electrode pattern includes a plurality of linear patterns extending in parallel to one another,
wherein no other conductor pattern that faces the capacitor electrode pattern through an insulating material is provided between the capacitor electrode pattern and the magnetic body, and
wherein no other conductor pattern is provided at a position on the second surface of the substrate that overlaps the capacitor electrode pattern.
